(19) United States
(12) Patent Application Publication
(10) Pub. No.: US 2008/0256488 A1
(43) Pub. Date: Oct. 16, 2008

(54) Method and Apparatus for Enabling Browsing of Images

(75) Inventors: Bartel Marinus Van De Sluis, Eindhoven (NL); Wilhelmus Franciscus Johannes Fontijn, Eindhoven (NL); Koen Hendrik Johan Vrielink, Eindhoven (NL); Mark Henricus Verberkt, Eindhoven (NL); Albert Maria Arnold Rijckaert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,003

(22) PCT Filed: Sep. 18, 2006
(86) PCT No.: PCT/IB2006/053342

§ 371 Date: Mar. 25, 2008

(30) Foreign Application Priority Data
Sep. 30, 2005 (EP) 05109106.4

(51) Int. Cl. G06F 3/048

(52) U.S. Cl. 715/810

(57) ABSTRACT

Method and apparatus for enabling to browse a plurality of stored images in which a plurality of the images (101) are displayed. Each image has at least one label (103) associated therewith. Each label comprises at least one attribute and an associated value. A representation of the label is provided. At least one attribute can be selected and at least a further one of the images having the same value as that of the selected attribute is retrieved.

### FIELD OF THE INVENTION

The present invention relates to browsing stored images. In particular, but not exclusively, it relates to browsing digital images, such as photographs stored in a digital camera or on a computer system.

### BACKGROUND OF THE INVENTION

Digital storage of images, for example digital photographs, allows a collection of images to be presented on an electronic display in any possible order. Images can be selected and ordered based on information such as time of creation, creator, event, person, object, place of creation etc or any combination thereof.

Invariably, in existing systems for browsing digital images, such as digital photographs, metadata associated with the images is also stored. The metadata may include information such as date and time the image was captured, at which event or the place at which the image was captured. It may also identify the persons or objects captured in the image. The metadata may be generated automatically from various data sources, for example persons can be recognised by face recognition techniques. Alternatively, the user can add or edit metadata manually. The metadata provides a useful source for sorting, ordering and retrieval of the images. A user may wish to display all images taken at a particular event and these can be selected and retrieved by use of the metadata. From these selected images, the user may wish to select a sub category such as those captured on a particular date or time during a particular event or featuring a particular person.

An example of a known browser for digital images is discussed in the paper “Simplifying the Management of Large Photo Collections” by Girgensohn et al. of FX Palo Atto Laboratory, Apr. 5, 2005. Digital images or photographs are displayed as a light table or photo viewer and a tree view provides the user with a visual display of the photo categories and enables navigation of the photographs in terms of these categories.

To enable navigation of the photographs, it is necessary to include the tree view on the screen. Therefore, the photographs that can be displayed on the light table is limited as full use of the screen can not be made. This becomes increasingly significant in the case where the screen is small such as a screen integral with the digital camera or mobile telephone, or the like.

### SUMMARY OF THE INVENTION

Therefore, it is desirable to provide a more flexible and useful retrieval and browsal system of stored images which also maximises screen usage. This is achieved, according to an aspect of the present invention, by a method for enabling to browse a plurality of images, the method comprising the steps of: providing an image, said image having at least one label associated therewith, said at least one label comprising at least one attribute of said image and an associated value; providing a representation of said at least one label; enabling to select one of said at least one attributes from said displayed label; and determining at least a further one of the images with an attribute which has the same value as that of the selected attribute. The image may be a photograph or a video segment, for example.

This is also achieved, according to another aspect of the present invention, by an apparatus for enabling to browse a plurality of images, the apparatus comprising: a storage means for storing a plurality of images; means for providing an image, said image having at least one label associated therewith, said at least one label comprising at least one attribute of said image and an associated value; means for providing a representation of said at least one label; means for enabling to select one of said at least one attributes from said at least one label; and means for determining at least a further one of the images with an attribute which has the same value as that of the selected attribute. The apparatus may be a portable device like a mobile phone and/or a digital camera.

The representation of a label may be displayed automatically or in the form of a pop-up. The pop-up may be activated by the movement of the cursor on the screen over a designated area of the screen. The label may contain a single attribute or a list of attributes associated with an image. The image may have a number of labels associated therewith which may comprise any combination of a list of attributes and/or attribute values or pictorial representation of these, such as generic icons. Alternatively, a label may be represented within the image itself, e.g. by an object or person captured by the image. The object or person has an attribute value associated therewith which can be selected by selecting the object or person captured by the image. Further, the label may be represented by a designated area of the screen which has an attribute value associated therewith which can be selected by selecting the designated area which effectively selects the attribute value associated with that area or region.

In this way, a user can retrieve and browse through many images without the need of a navigation panel. Therefore, full use of the screen is made to display the images.

### BRIEF DESCRIPTION OF DRAWINGS

For a more complete understanding of the present invention, reference is made to the following description taken in conjunction with the accompanying drawings, in which:

FIGS. 1 to 3 illustrate a schematic different views of a display screen of the system according to an embodiment of the present invention.

### DETAILED DESCRIPTION OF PREFERRED EMBODIMENTS

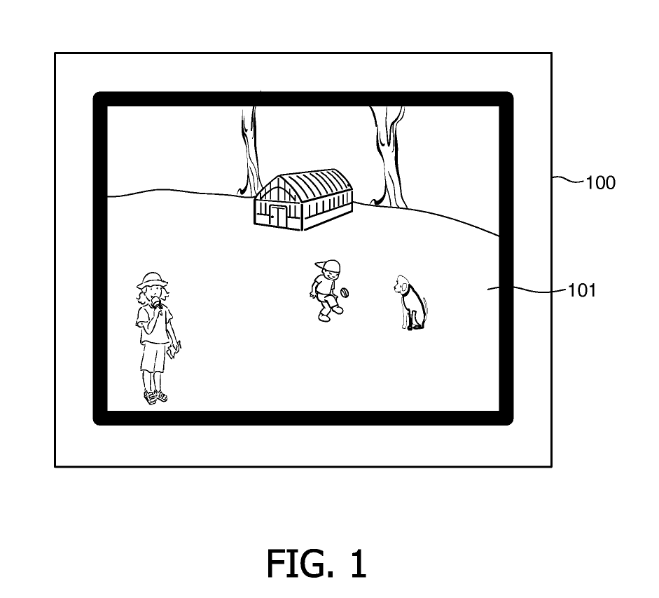

A preferred embodiment of the present invention will now be described with reference to FIGS. 1 to 3.

FIG. 1 illustrates a schematic of a screen 100 of the system according to an embodiment of the present invention. The screen 100 may be a TV screen, a display screen integral with an image capture device (such as a digital camera), a computer screen or the like. An image 101, such as a digital photograph is displayed on the screen 100. A single photograph is illustrated here but it can be appreciated that a number of images may be displayed in a tile format.

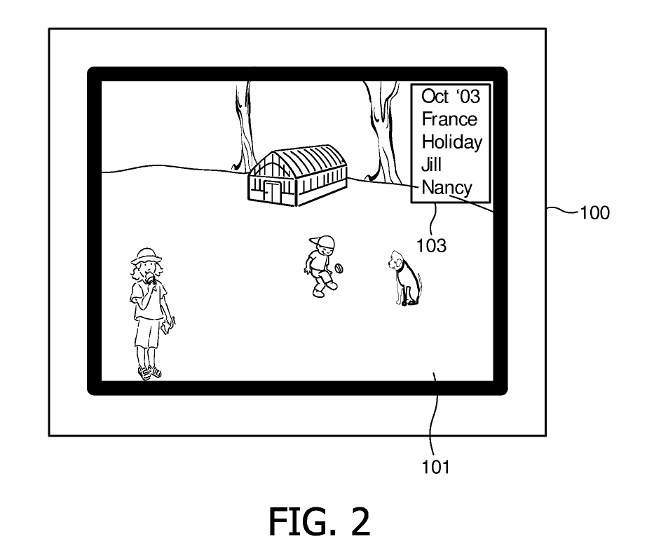

Each digital image 101 has a plurality of attributes and attribute values associated with it. These can be displayed in a label such an overlay 103 as shown in FIG. 2. The overlay 103 shown in FIG. 2 comprises a list of attribute values. The label 103 may be presented on the screen 100 by default, as shown, or as a result of user action, for example the user could press an information button to see the label information on when, where and who etc, or movement of the cursor to that area of the screen may cause the label to appear. The label can, alternatively, be presented on the screen 100 outside of the image 101, around the image or at a separate area of the screen. Instead of presenting the textual content of the labels as shown here, visual elements may be used that represent the attributes and their values. For example, generic icons can represent the dimensions such as time, place, person etc. The labels could also be represented by selection of a designated area or region of the screen, or alternatively, objects or persons captured by the image can be selected by the cursor etc. The region of the screen or the object or person has an attribute and attribute value associated therewith. Thus, selection of the region, object or person causes selection of at least one image having that attribute value. The label 103 may comprise any combination of these.

The user can then easily select another set or collection of images by selecting one of the attribute values displayed in the label 103.

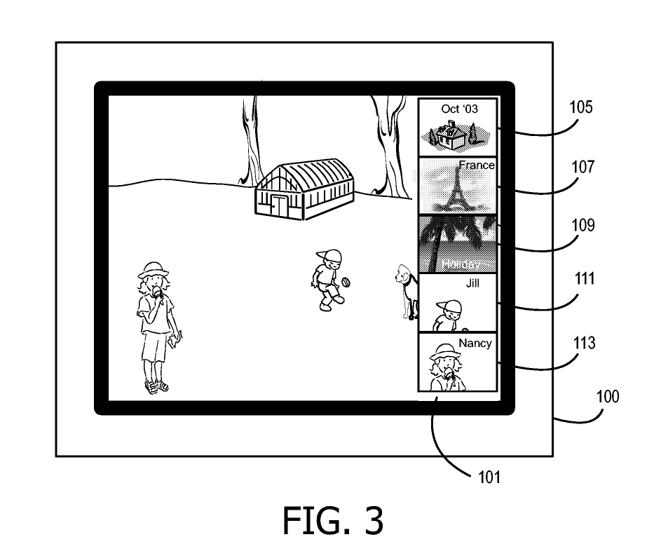

Alternatively, the attribute values may be listed in the label graphically as shown in FIG. 3. Each attribute value is illustrated by a corresponding image 105, 107, 109, 111, 113 in a “reduced” format. The user can highlight one of the reduced images to select images having that attribute value. Further, the reduced sized image can be used to present the attribute value of the next set as soon as the user selects a corresponding set.

The selection and ordering of the images within a selected set can be done in various ways. For example, the set or collection of images can be displayed such that all images are displayed on the screen at the same time in a tile format, or alternatively, a single image may be displayed and subsequent images viewed by use of a scroll bar or “next” arrow. On browsing the selected set of images, the user may wish to continue browsing images of a specific person, i.e. a different attribute featured in one of the current images. The user can do this by selecting the attribute of “person” having the value required in the label 103, for example. The system then retrieves all images of that person and displays them on the screen 100 and their associated labels.

The images can be displayed in a particular order. For events (such as holidays, Christmas, birthdays), these can be displayed chronologically. It is also possible to let the user determine the sequencing. For instance, the left-right buttons of the “mouse” could be used to browse chronologically whereas some other button enables random jumps in the sequence of images of the current set.

The browser of the preferred embodiment may be used in a specific mode. For example, a connected display, such as a TV with connected E-Hub. The browser of the preferred embodiment may have three different modes of operation, and the user would be able to seamlessly switch from one mode to another, for example: a photograph frame mode which comprises an automatic ‘end-less’ slideshow based on semi-random selection of images from a collection; an album browsing mode which enables browsing in a conventional way through an album (e.g. a birthday album, holiday album, Jim's album, Ducati album); and an explorative navigation mode which has the ability to browse images along a particular dimension, this mode can be entered from either of the modes previously mentioned by some form of user action, for example, pressing an information button, or an explore button).

Although a preferred embodiment of the present invention has been illustrated in the accompanying drawings and described in the foregoing detailed description, it will be understood that the invention is not limited to the embodiment disclosed, but is capable of numerous modifications without departing from the scope of the invention as set out in the following claims.

1. A method for enabling to browse a plurality of images, the method comprising the steps of:
providing an image, said image having at least one label associated therewith, said at least one label comprising at least one attribute of said image and an associated value;
providing a representation of said at least one label;
enabling to select one of said at least one attributes from said displayed label; and
determining at least a further one of the images with an attribute which has the same value as that of the selected attribute.

2. A method according to claim 1, wherein the step of enabling to select one of said at least one attributes comprises enabling to select a person or object in the stored image.

3. A method according to claim 1l, wherein said representation of said at least one label comprises at least one attribute and value displayed in a pop up.

4. A method according to claim 1, wherein said representation of said at least one label is displayed in a region in the vicinity of its associated image.

5. A method according to claim 1, wherein said representation of said at least one label is an overlay of its associated image.

6. A method according to claim 1, wherein the attributes and their values are generated automatically.

7. A method according to claim 1, wherein visual elements represent said at least one label.

8. A method according to claim 7, wherein the visual elements comprises generic icons.

9. Apparatus for enabling to browse a plurality of images, the apparatus comprising:
a storage means for storing a plurality of images;
means for providing an image, said image having at least one label associated therewith, said at least one label comprising at least one attribute of said image and an associated value;
means for providing a representation of said at least one label;
means for enabling to select one of said at least one attributes from said at least one label; and
means for determining at least a further one of the images with an attribute which has the same value as that of the selected attribute.

10. A computer program product comprising a plurality of program code portions for carrying out the method according to claim 1.
